(19) United States
(12) Patent Application Publication
(10) Pub. No.: US 2020/0186550 A1
(43) Pub. Date: Jun. 11, 2020

(54) METHOD AND A SYSTEM FOR DETECTING AN INTRUSION ON A NETWORK

(71) Applicant: Symbiosis International (Deemed University), Pune (IN)

(72) Inventors: Nisha T. N, Pune (IN); Dhanya PRAMOD, Pune (IN)

(21) Appl. No.: 16/364,393

(22) Filed: Mar. 26, 2019

(30) Foreign Application Priority Data
Dec. 6, 2018 (IN) 201821046234

(51) Int. Cl. H04L 29/06; G06N 7/00; G06N 5/02

(52) U.S. Cl. CPC H04L 63/1416; G06N 5/02; G06N 7/005; H04L 63/1425

(57) ABSTRACT

A system and method for detecting an intrusion on a network is described herein. The system comprises a processor 201 and memory 203. The processor 201 may sniff and analyse a header data of each packet and further create a plurality of network events on the basis of a content of each packet. The processor 201 may identify a pattern of the plurality of network events in the network data flow using a knowledge based finite state machine. The identified pattern is then fed into an Incremental Probability Action Modelling (IPAM) engine to predict a next state in the identified pattern based on a probability of network events. The processor 201 may prepare a probability grid with the probability of the next state as a warning state. The processor 201 may generate, one or more alerts of the intrusion detection on the basis of prediction of the warning state.

### CROSS-REFERENCE TO RELATED APPLICATIONS AND PRIORITY

The present application does claim priority from Indian Patent Application No. 201821046234 filed on 6 Dec. 2018.

### TECHNICAL FIELD

The present subject matter described herein, in general, relates to intrusion/attack detection on an enterprises network. Particularly, the present subject matter provides system and method for detecting an intrusion on a network.

### BACKGROUND

The subject matter discussed in the background section should not be assumed to be prior art merely because of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

Intrusion detection system is a system that monitors network traffic for suspicious activity and issues alert when such activity detected in the network. Many network intrusion detection systems reconstruct higher level interaction between end host and remote user in order to identify anomalous behaviour. Some systems for intrusion detections use the network data such as source IP address and destination IP address to quantify and group the network activity. Such systems are configured to use Finite state machine (FSA) in order to model the activity to create a behaviour profile. Although all knowledge-based models of Finite state machine enable intrusion detection for potentially malicious activity by monitoring networks, but they are prone to false or negative alarms. Therefore, there is long standing need of system and method for reducing false and negative alarms in an intrusion detection system.

Therefore, there is long standing need of system and method for detecting the intrusion on a network.

### SUMMARY

This summary is provided to introduce concepts related to system and method for detecting an intrusion on a network and the concepts are further described below in the detailed description. This summary is not intended to identify essential features of the claimed subject matter nor is it intended for use in determining or limiting the scope of the claimed subject matter.

In one embodiment, a system for detecting an intrusion on a network is disclosed. The system comprises a processor and a memory. The processor may be configured to execute programmed instructions stored in the memory. The processor may be configured to execute instructions for sniffing, each packet of a plurality of packets, wherein the plurality of packets is captured across a network data flow. Further, the processor may be configured to execute instructions for analysing, a header data of each packet of the plurality of packets. The processor may be further configured to execute instructions for creating, a plurality of network events on the basis of a content of each packet. Further, the processor may be configured to execute instructions for identifying, a pattern of the plurality of network events in the network data flow based on a knowledge based finite state machine defined between each pair of computers connected in the network. The processor may further be configured to execute instructions for feeding, identified pattern of the plurality of network events into an Incremental Probability Action Modelling (IPAM) engine in order to predict a next state in the identified pattern based on a probability of network events. Further, the processor may be configured to execute instructions for preparing, a probability grid with the probability of the next state as a warning state, wherein the probability grid is used in order to predict a network status of each state. Furthermore, the processor may be configured to execute instructions for generating, one or more alerts of the intrusion detection on the basis of prediction of the warning state.

In another embodiment, a method for detecting an intrusion on a network is disclosed. The method may include sniffing, via a processor, each packet of a plurality of packets, wherein the plurality of packets is captured across a network data flow. The method may further include analysing, via the processor, a header data of each packet of the plurality of packets. Further, the method may include creating, a plurality of network events on the basis of a content of each packet. The method may further include identifying, via the processor, a pattern of the plurality of network events in the network data flow based on a knowledge based finite state machine defined between each pair of computers connected in the network. Further, the method may include feeding, via the processor, identified pattern of the plurality of network events into an Incremental Probability Action Modelling (IPAM) engine in order to predict a next state in the identified pattern based on a probability of network events. The method may further include preparing, via the processor, a probability grid with the probability of the next state as a warning state, wherein the probability grid is used in order to predict a network status of each state. Furthermore, the method may include generating, via the processor, one or more alerts of the intrusion detection on the basis of prediction of the warning state.

### BRIEF DESCRIPTION OF DRAWINGS

The detailed description is described with reference to the accompanying Figures. In the Figures, the left-most digit(s) of a reference number identifies the Figure in which the reference number first appears. The same numbers are used throughout the drawings to refer like features and components.

FIG. 1 illustrates an implementation 100 of a system 101 for detecting an intrusion on a network, in accordance with an embodiment of the present subject matter.

FIG. 2 illustrates components of the system 101, in accordance with an embodiment of a present subject matter.

FIG. 3 illustrates an architecture of the system 101, in accordance with an embodiment of a present subject matter.

FIG. 4 illustrates a connection FSA, in accordance with an embodiment of a present subject matter.

FIG. 5 illustrates a network FSA, in accordance with an embodiment of a present subject matter.

FIG. 6 illustrates a method for detecting an intrusion on a network, in accordance with an embodiment of the present subject matter.

### DETAILED DESCRIPTION

Reference throughout the specification to “various embodiments,” “some embodiments,” “one embodiment,” or “an embodiment” means that a particular feature, structure, or characteristic described in connection with the embodiment is included in at least one embodiment. Thus, appearances of the phrases “in various embodiments,” “in some embodiments,” “in one embodiment,” or “in an embodiment” in places throughout the specification are not necessarily all referring to the same embodiment. Furthermore, the particular features, structures or characteristics may be combined in any suitable manner in one or more embodiments.

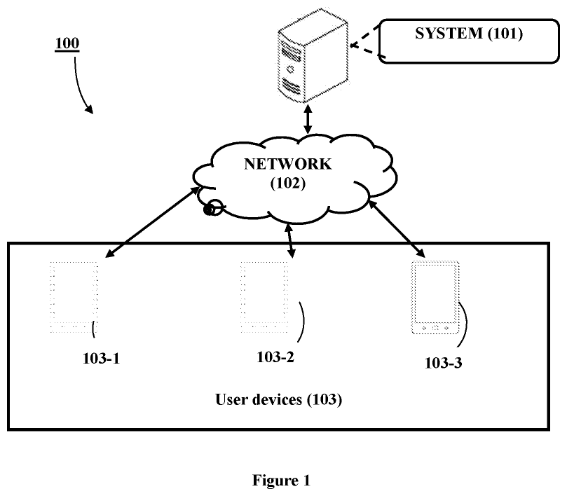

Referring to FIG. 1, an implementation 100 of a system 101 for detecting an intrusion on a network is illustrated in accordance with an embodiment of the present subject matter. In one implementation, the system 101 may be connected to a user device 103 through a network 102. It will be understood that the system 101 may be accessed by multiple users through one or more user devices 103-1, 103-2, 103-3, collectively referred as user device 103 hereinafter, or user 103, or applications residing on the user device 103.

In an embodiment, as illustrated in FIG. 1, the system 101 may accept information provided by multiple users 103-1, 103-2, 103-3 using the user device 103, to register the respective user with the system 101.

In an embodiment, though the present subject matter is explained considering that the system 101 is implemented as a server, it may be understood that the system 101 may also be implemented in a variety of user devices, such as a but are not limited to, a portable computer, a personal digital assistant, a handheld device, a mobile, a laptop computer, a desktop computer, a notebook, a workstation, a mainframe computer, and the like.

In one implementation, the network 102 may be a wireless network, a wired network or a combination thereof. The network 102 can be accessed by the device using wired or wireless network connectivity means including updated communications technology.

In one implementation, the network 102 may be a wireless network, a wired network or a combination thereof. The network 102 can be implemented as one of the different types of networks, cellular communication network, local area network (LAN), wide area network (WAN), the internet, and the like. The network 102 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further, the network 102 may include a variety of network devices, including routers, bridges, servers, computing devices, storage devices, and the like.

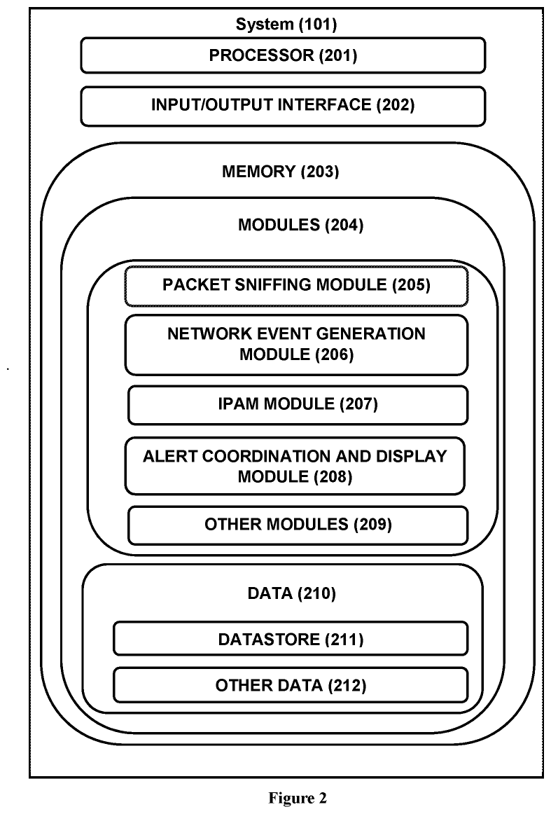

Referring to FIG. 2, components of the system 101, comprises at least one processor 201, an input/output (I/O) interface 202, a memory 203, modules 204 and data 210. In one embodiment, the at least one processor 201 is configured to fetch and execute computer-readable instructions stored in the memory 203.

In one embodiment, the I/O interface 202 implemented as a mobile application or a web-based application may include a variety of software and hardware interfaces, for example, a web interface, a graphical user interface, and the like. The I/O interface 202 may allow the system 101 to interact with the user devices 103. Further, the I/O interface 202 may enable the user device 103 to communicate with other computing devices, such as web servers and external data servers (not shown). The I/O interface 202 can facilitate multiple communications within a wide variety of networks and protocol types, including wired networks, for example, LAN, cable, etc., and wireless networks, such as WLAN, cellular, or satellite. The I/O interface 202 may include one or more ports for connecting to another server.

In an exemplary embodiment, the I/O interface 202 is an interaction platform which may provide a connection between users and system 101.

In an implementation, the memory 203 may include any computer-readable medium known in the art including, for example, volatile memory, such as static random-access memory (SRAM) and dynamic random-access memory (DRAM), and/or non-volatile memory, such as read only memory (ROM), erasable programmable ROM, flash memories, hard disks, optical disks, and memory cards. The memory 203 may include modules 204 and data 210.

In one embodiment, the modules 204 include routines, programs, objects, components, data structures, etc., which perform particular tasks, functions or implement particular abstract data types. In one implementation, the modules 204 may include a packet sniffing module 205, a network event generation module 206, an IPAM engine module 207, an alert coordination and display module 208, other modules 209.

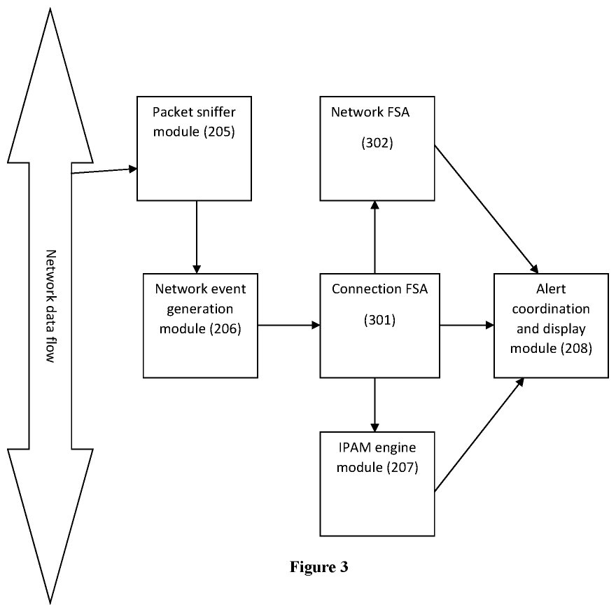

Now referring to FIG. 3, the architecture of the system 101 is disclosed in accordance with the present subject matter. In one embodiment, the architecture of the system 101 may comprises the packet sniffer module 205, the network event generation module 206, the IPAM engine module 207, a connection FSA 301, a network FSA 302, and the alert coordination and display module 208.

Now referring to FIG. 2 and FIG. 3, the packet sniffing module 205 may configured to sniff, each packet of a plurality of packets. In one embodiment, the plurality of packets may be collected across a network data flow. In one exemplary embodiment, sniffing program unpacks the three-layer header details based on IEEE 802.3(Ethernet Frame), RFC 791 (IP) and RFC 793 header specification.

In one embodiment, the network event generation module 206 may analyse a header data of each packet of the plurality of packets. Further, the network generation module 206 may be configured to create a plurality of network events on the basis of a content of each packet.

In one embodiment, the system 101 may configured to identify, a pattern of the plurality of network events in the network data flow using a knowledge based finite State Machine. In one embodiment, the knowledge based finite State Machine may be defined between each pair of computers connected in the network. In one embodiment, Finite State Machine is also referred as Finite State Automata (FSA). Finite State Machine (FSM) or Finite State Automaton (FSA) is a mathematical model of computation. It is an abstract model of a machine, the implementation of which may be observed in any device which performs a predefined sequence of actions based on prescribed inputs or events. FSAs may be defined by finite number of states, one in which the machine can be at an instance of time and a change from one state to another; known as transaction, as a response to some external input. Mathematically, the FSM may be defined as the Finite State Automata (Deterministic Finite Automata). In one embodiment, Finite state Automata may be defined as a five-tuple notation M=(Q, Σ, δ, q0, F)

where
finite set of states denoted by Q;
finite set of input symbols denoted by Σ
a transition Function, denoted by δ, which takes as arguments a state and an input symbol and returns a state. If q is a state and a is an input symbol, then δ(q, a) is that state p such that there is an arc labelled from q to p;
a start state q0, where q0ϵQ;
a set of final or accepting states F, where F is a subset of Q

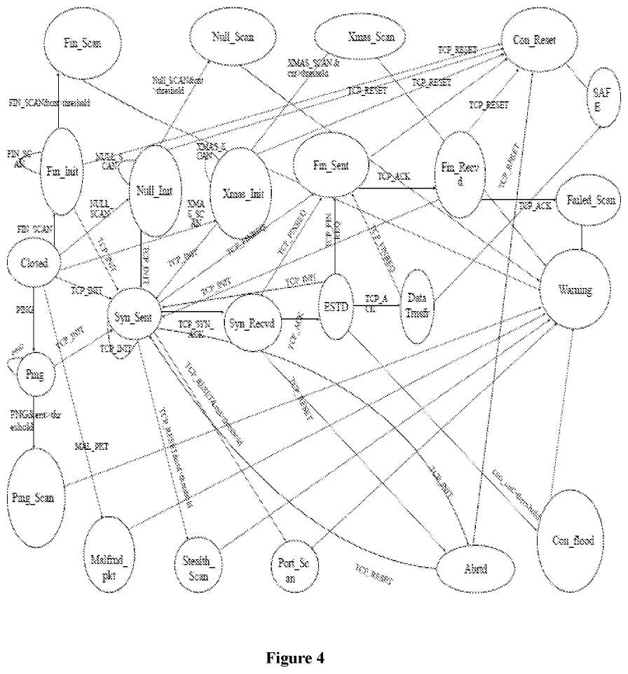

In one embodiment, the FSA may take the form of sequence detector (Acceptor/Recognizer) which produces a binary output to indicate whether a given input is accepted by the machine or not. Here, the input may be a sequence of symbols (characters), defined as regular language and the acceptance, defined if the string can take the machine into any one of the final states defined in FSA. In computer domain, Finite State Machines may be implemented as a software component. In one embodiment, the Virtual Finite State Machine (VFSM) may provide a software specification of FSM. In one embodiment, states and transitions may be defined as abstract classes in any Object Oriented Programming language, from which the FSA defined states and transitions are implemented. The transitions may be triggered by user inputs events and the FSA execution is monitored. This model may construct two finite state machines, known as CONNECTION_FSA and NETWORK_FSA. In one embodiment, the CONNECTION_FSA may define the communication between each pair of IP addresses in the network. In one embodiment, the NETWORK_FSA may define the state of network as a whole. In one embodiment, FSA may be used to generate the network events sequence between each pair of IP. Now referring to FIG. 3 and FIG. 4, the connection FSA 301 may be defined on the basis of formal specification of FSA. In one embodiment, the connection FSA 301 is configured to embrace all possible states of Finite State Machines, when two different IP addresses communicate(Q) and the network events generated by the network flow data as the input alphabet Σ.

In one embodiment, Q refers to the set of all possible 24 states of the machine, when two different IP addresses communicate with each other. It may include all activities such as pinging a system, three-way handshaking for initiating a connection, resetting a connection and different scanning techniques.

TABLE 1
Network Events

| SR | | |
|---|---|---|
| No | Event Name | Description |
| 1 | TCP_INIT | syn flag set. |
| 2 | TCP_ACK | ack flag set |
| 3 | TCP_SYN_ACK | syn and ack flags set |
| 4 | TCP_FIN_REQ | ack and fin flags set |
| 5 | TCP_RESET | ack and rst flags set |
| 6 | XMAS_SCAN | All flags set |
| 7 | FIN_SCAN | fin flag set |
| 8 | NULL_SCAN | No flags set |
| 9 | PING | ICMP request |
| 10 | MAL_PKT | Source and destination |
| | | address wrongly defined. |

Now referring to table 1 of network events, the ten events may be generated by the network flow data, wherein the ten events may be the input alphabet Σ to the DFA defined. In automata theory, state transition table shows what state the FSA may move to next state, based on the current state and input event. The State transition table (table 2) is arranged in the following manner

TABLE 2
State transition table

| State | Event | | | |
|---|---|---|---|---|
| (Current) | E₁ | E₂ | . . . | Eₙ |
| S₁ | — | — | . . . | Sx/Ai |
| S₂ | S_{y}/Aⱼ | — | . . . | — |
| . . . | . . . | . . . | . . . | . . . |
| Sₘ | — | Sz/Ak | . . . | — |

### Wherein, S=State,

E=Event,
A=Action,
_=Impossible Transition
Sy/Aj=The next state the FSA will be on finding event E1, when it is on S2

In one embodiment, rows of table 2 indicate the current states and columns of table 2 indicate the events. The cells where the row and column intersect indicate the next state that FSA may move to on occurrence of a particular event or the action to be performed. The sequence of states of the FSA may transit based on event recorded for each pair. In one embodiment, CLOSED state may be an initial state of the DFA. In one embodiment, WARNING and SAFE states are two ending states of the DFA. In one embodiment, following aspects may be taken into consideration while constructing the automata from the network events.
Each state remembers that certain events have happened, and others have not happened. Transition between the states takes place when one of those events happens.
The FSA can ignore an event on which a transition is not defined. The automata can loop in the same event, preventing the event from killing the automata.

In one embodiment, transition function δ may defined by considering above assumptions and the transition table is given below in the table 3: States of connection FSA.

TABLE 3
States of Connection FSA

| SR | | |
|---|---|---|
| No | State Name | Description |
| 1 | Closed | Initial state; No packets transferred. |
| 2 | Syn_Sent | SYN packet transferred from sender |
| 3 | Syn_Received | SYN packet received at the receiver |
| 4 | Aborted | Connection aborted |
| 5 | Established | Connection established |
| 6 | Fin_Sent | Initial FIN sent |
| 7 | Fin_Received | FIN request received |
| 8 | Con_Reset | Connection Reset |
| 9 | Ping | Ping packet find |
| 10 | Ping_Scan | Ping scan suspected |
| 11 | Port_Scan | Port scan suspected |
| 12 | Stealth_Scan | Stealth scan suspected |
| 13 | Xmas_Init | Xmas scan packet found |
| 14 | Xmas_Scan | Xmas scan suspected |
| 15 | Fin_Init | FIN scan packet found |
| 16 | Fin_Scan | FIN scan suspected |
| 17 | Null_Init | NULL scan packet found |
| 18 | Null_Scan | NULL scan suspected |
| 19 | Con_Flood | Connection flood |
| 20 | MalFormed_Pkt | Malformed packet found |
| 21 | Failed_Scan | Failed scan found |
| 22 | Data_Transfer | Data transfer stage |
| 23 | Safe_State | Safe state (Ending State) |
| 24 | Warning_State | Warning state (Ending State) |

Now referring to table 3, all 24 states of connection FSA are described. Now referring to table 4, state transition matrix for connection FSA is illustrated, in accordance with the present subject matter. In one exemplary embodiment, State transition matrix comprises plurality of columns and rows. In one embodiment, rows of table 4 indicate the current states and columns indicate the events. The second column in the table (immediately after the states column) indicates the default transactions from those states, irrespective of the event. The intersecting cell of a State (Si) and Event (Ej) indicates the next state (Sj) that the FSA will move. This implementation does not consider the action (Aj) for the transmission. Now referring to FIG. 4 and table 4, if the current state is closed and next event is TCP_INIT, then the FSA may move to next state “SYN_SENT”. In another exemplary embodiment, if current state is Syn_Recvd i.e. SYN packet received at the receiver and next event is TCP_ACK, then next state the FSA may move next state “ESTD”.

TABLE 4
State Transition Matrix for Connection FSA

| | Events | | | | | |
|---|---|---|---|---|---|---|
| States | | FIN_SCAN | MAL_PKT | NULL_SCAN | PING | TCP_ACK |
| CLOSED | — | FIN_INIT | MALFRMD_PKT | NULL_INIT | PING | — |
| SYN_SENT | — | — | — | — | — | — |
| SYN_RECVD | — | — | — | — | — | ESTD |
| ESTD | CON_FLOOD | — | — | — | — | DATA_TRSFR |
| ABRTD | — | — | — | — | — | — |
| PING | — | — | — | — | PING_SCAN | — |
| PING_SCAN | — | — | — | — | — | — |
| PORT_SCAN | WARNING | — | — | — | — | — |
| STEALTH_SCAN | WARNING | — | — | — | — | — |
| MALFRMD_PKT | WARNING | — | — | — | — | — |
| CON_FLOOD | WARNING | — | — | — | — | — |
| DATA_TRSFR | Safe | — | — | — | — | — |
| WARNING | — | — | — | — | — | — |
| NULL_INIT | — | — | — | NULL_SCAN | — | — |
| FIN_INIT | — | FIN_SCAN | — | — | — | — |
| XMAS_INIT | — | — | — | — | — | — |
| FIN_SCAN | WARNING | — | — | — | — | — |
| Safe | — | — | — | — | — | — |
| NULL_SCAN | WARNING | — | — | — | — | — |
| XMAS_SCAN | WARNING | — | — | — | — | — |
| FIN_SENT | — | — | — | — | — | FIN_RECVD |
| FIN_RECVD | — | — | — | — | — | FAILED_SCAN |
| CON_RESET | Safe | — | — | — | — | — |
| FAILED_SCAN | WARNING | — | — | — | — | — |

| | Events | | | | |
|---|---|---|---|---|---|
| States | TCP_FIN_REQ | TCP_INIT | TCP_RESET | TCP_SYN_ACK | XMAS_SCAN |
| CLOSED | — | SYN_SENT | — | — | XMAS_INIT |
| SYN_SENT | FIN_SENT | SYN_SENT | STEALTH_SCAN | SYN_RECVD | — |
| SYN_RECVD | FIN_SENT | — | ABRTD | — | — |
| ESTD | FIN_SENT | — | — | — | — |
| ABRTD | — | SYN_SENT | CON_RESET | — | — |
| PING | — | SYN_SENT | — | — | — |
| PING_SCAN | — | — | — | — | — |
| PORT_SCAN | — | — | — | — | — |
| STEALTH_SCAN | — | — | — | — | — |
| MALFRMD_PKT | — | — | — | — | — |
| CON_FLOOD | — | — | — | — | — |
| DATA_TRSFR | FIN_SENT | — | — | — | — |
| WARNING | — | — | — | — | — |
| NULL_INIT | — | SYN_SENT | CON_RESET | — | — |
| FIN_INIT | — | SYN_SENT | — | — | — |
| XMAS_INIT | — | SYN_SENT | CON_RESET | — | XMAS_INIT |
| FIN_SCAN | — | — | — | — | — |
| Safe | — | — | — | — | — |
| NULL_SCAN | — | — | — | — | — |
| XMAS_SCAN | — | — | — | — | — |
| FIN_SENT | — | — | — | — | — |
| FIN_RECVD | — | SYN_SENT | CON_RESET | — | — |
| CON_RESET | — | — | — | — | — |
| FAILED_SCAN | — | — | — | — | — |

As illustrated in FIG. 3, the architecture of system 101 further comprises the Network FSA 302. In one embodiment, the network Finite state automata (FSA) may define the status of the network on the basis of the states of each Connection FSA 301 at a given time. In one embodiment, a statistical data of the states provides the condition for the state change in the Network FSA 302.

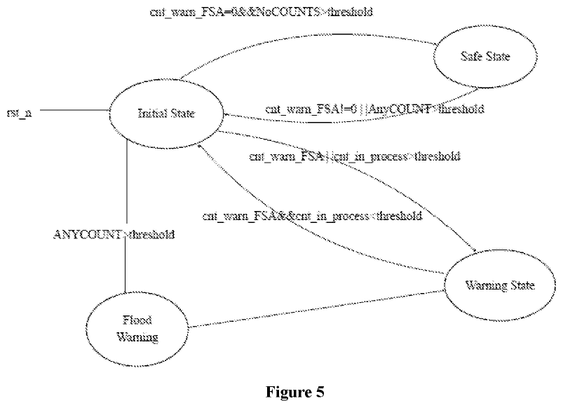

Now referring to FIG. 5, the network FSA is illustrated in accordance with an embodiment of the present subject matter. In one embodiment, the Network FSA specification may define the status of the entire network on the basis of the states that each Connection FSA and many count variables at a given time. The specification of Network FSA is explained with state transition table 5: State transition Matrix-Network FSA. Transition between the states of Network FSA may be executed by evaluating the statistical properties of the entire collection of Connection FSA in the network. The count of Connection FSAs in the SAFE, WARNING and processing states and the statistics of the different count variables provides the condition for the state change in the Network FSA.

TABLE 5
State transition of Network FSA

| | Events | | | | | |
|---|---|---|---|---|---|---|
| | | | cnt_warn_FSA! = 0 | cnt_warn_FSA | cnt_warn_FSA = 0 | cnt_warn_FSA |
| | | Any | ∥ | && | && | ∥ |
| | | COUNT > | Any COUNT > | cnt_in_process < | No COUNTS > | cnt_in_process > |
| States | | Threshold | threshold | Threshold | Threshold | Threshold |
| Initial | — | Flood | — | — | Safe | Warning |
| State | | Warning | | | State | State |
| Warning | — | — | — | Initial | — | — |
| State | | | | State | | |
| Safe | — | — | Initial | — | — | — |
| State | | | State | | | |
| Flood | Warning | — | — | — | — | — |
| Warning | State | | | | | |

In one exemplary embodiment, transition from initial state to flood warning state may occur, when any count is greater than threshold. In another exemplary embodiment, transition from initial state to safe state may occur, when cnt_warn_FSA is zero and No COUNTS is greater than threshold. In another exemplary embodiment, transition from safe state to initial state may occur, when cnt_warn_FSA is not zero or any count is greater than threshold. In another exemplary embodiment, transition from initial state to warning state may occur, when cnt_warn_FSA or count in process is greater than threshold. In another exemplary embodiment, transition from warning state to initial state may occur, when cnt_warn_FSA and count in process is less than threshold.

Now again referring to FIG. 2 and FIG. 3, the connection FSA 301 may be configured to feed an identified pattern of the plurality of network events into an Incremental Probability Action Modelling (IPAM) engine in order to predict a next state in the identified pattern based on a probability of network events. In one embodiment, the IPAM engine may use the Incremental Probabilistic Action Modelling (IPAM) developed by Davison and Hirsh. In one embodiment, IPAM may be a learning algorithm that predicts the next command in a sequence by maintaining a probability distribution of all the commands. In one embodiment, the IPAM engine module 207 may be configured to provide the probability of all the network events in the set.

In one embodiment, the system 101 may create a finite state machine for each connection in the network and handles all different type of communications happening between those pairs of IPs, irrespective of the protocol used. As per the concept of “subset construction” the transition function of DFA may map a state S which is a subset of Q and an input symbol x to the set T(S,x)=U {T(q,x)|qϵS}, the set of all states that may be reached by symbol x from S. Set S is a set of all states that the DFA travels through when consuming the input string. This subset of Q is collected and is provided to the IPAM machine for the prediction of the next state.

In one embodiment, the IPAM engine module 207 may be configured to prepare a probability grid with the probability of the next state as a warning state. In one embodiment, the probability grid is used in order to predict a network status of each state. The details of preparation of the grid by the IPAM engine module 207 is described hereinafter as below.

In an embodiment, the IPAM engine module 207 may implement “The Incremental Probabilistic Action Modelling” (IPAM) proposed by Davison and Hirsh, wherein the IPAM is a learning algorithm that predicts the next command in a sequence by maintaining a probability distribution of all the commands that may follow. For example, Let Σ be a set of all possible input signals. Let A=a₁ a₂ a₃ . . . aₙ, a_{j ϵ}Σ be a sequence of input symbol in which first i symbols, a₁, a₂, . . . , aᵢ have already observed. This algorithm predicts the probability for each symbol xϵΣ, to be the next element in the sequence. Σ here will be the sequence of events created by the CONNECTION FSA when it traverses through the states at the reception of each packet data in the network. We are starting with a uniform IPAM probability table with value 1/N where N is the total number of distinct commands in the data set. The table is updated on arrival of each new character in the following manner

$$P ( x \vert {a}_{1} {a}_{2 …} {a}_{i} ) = P ( x \vert {a}_{i} )$$

$$P ( x \vert y ) = \{ \begin{matrix}α P ( x \vert {a}_{i} ) + ( 1 - α ) , & if x = {a}_{i} + 1 \\ α P ( x \vert {a}_{i} ) , & otherwise\end{matrix}$$

TABLE 6
Probability Grid (Prob1, Prob2, Prob3 . . . indicating
multiple probability values calculated)

| Attack | Src IP | Dest IP | Prob1 | Prob2 | . . . | . . . |
|---|---|---|---|---|---|---|
| Ping Scan | 10.10.57.119 | 10.10.56.2 | 0.03125 | 0.02 | 0.016 | 0.025 |
| Intense | 10.10.57.124 | 10.10.57.119 | 0.03125 | 0.025 | 0.02 | 0.0128 |
| scan | | | | | | |
| Regular | 10.10.57.123 | 10.10.57.119 | 0.03125 | 0.025 | 0.016 | 0.0128 |
| scan | | | | | | |
| X mas | 10.10.57.119 | 10.10.57.112 | 0.025 | 0.02 | 0.016 | 0.025 |
| scan | | | | | | |
| Intense | 10.10.57.117 | 10.10.57.119 | 0.03125 | 0.025 | 0.02 | 0.016 |
| scan no | | | | | | |
| ping | | | | | | |
| Intense | 10.10.57.120 | 10.10.57.119 | 0.03125 | 0.025 | 0.02 | 0.016 |
| scan | | | | | | |
| plus udp | | | | | | |
| Hping | 10.10.57.118 | 10.10.57.119 | 0.03125 | 0.025 | 0.02 | 0.016 |
| flood | | | | | | |
| ping flood | 10.10.57.119 | 10.10.57.11 | 0.03125 | 0.025 | 0.02 | 0.016 |
| windows | | | | | | |
| Slow | 10.10.57.139 | 10.10.57.119 | 0.03125 | 0.025 | 0.02 | 0.016 |
| compre- | | | | | | |
| hensive | | | | | | |
| scan | | | | | | |

The prediction is considered to be good if the next letter is one among the top four predicted commands. Accordingly, an alarm may be raised. The parameter a is varied from 0.85 to 0.99.

The set of events defined by CONNECTION FSA for each pair of IP (Internet Protocol Address) is the input Σ to the IPAM engine. Even though the IPAM engine provides the probability of all the actions (events) in the set, we are interested only on the probability of the state WARNING. Probability grid is prepared as shown below with the probability of next state to be the WARNING state and is used to predict the network status at each stage. A sample of probability grid calculated for some attacks is depicted in Table 6 appended below. The probability is calculated for each packet transferring between those pairs, which results in updating probability grid in real time generating a large data.

It must be understood that the IPAM enables in computing multiple probability values, and only few of the multiple probability values calculated are depicted in the above Table 6 for reference.

In one embodiment, the alert coordination and display module 209 may be configured to generate, one or more alerts of the intrusion detection on the basis of prediction of the warning state. Now referring to FIG. 3, the alert coordination and display module 209 may be configured to detect intrusion at three different stages of intrusion by generating alert at the Connection FSA, the IPAM engine probability alert and the Network FSA alert. In one embodiment, the alert coordination and display module 209 may be configured to coordinate three alerts of three different stages using a decision tree. In one embodiment, the decision tree may provide a network safety ranking from 0 to 7, wherein 7 is highly danger state and 0 is the safe state. In one embodiment, the alert coordination based intrusion detection may also provide better detection probabilities and early detection which can be used to rank the network according to the severity of attacks. In one embodiment, the alert coordination and display module 208 may makes the network attack detection sensitive towards the Distributed Denial of Service (DDoS) attacks.

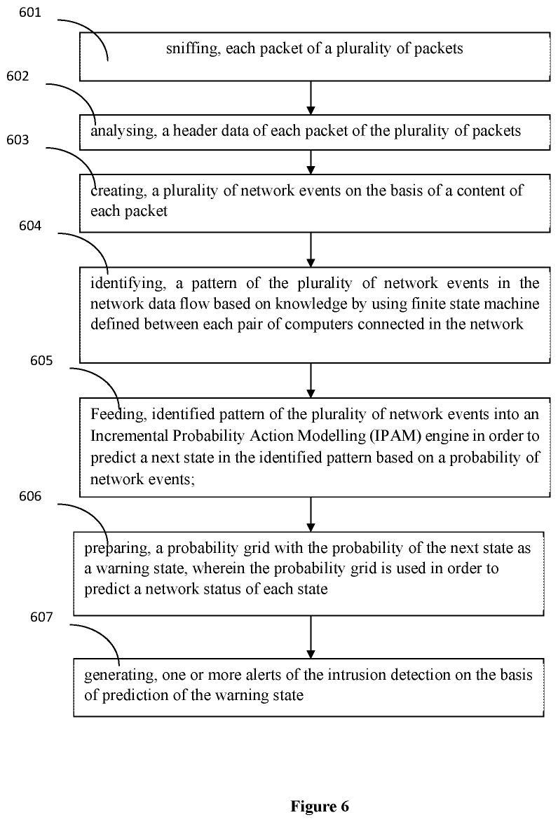

Now referring to FIG. 6, a method for detecting an intrusion on a network is illustrated, in accordance with an embodiment of the present subject matter is disclosed.

At step 601, the packet sniffing module 205 may be configured for sniffing each packet of the plurality of packets. In one embodiment, the plurality of packets may be captured across the network data flow.

At step 602, the network event generation module 206 may be configured for analysing, a header data of each packet of the plurality of packets.

At step 603, the network event generation module 206 may be configured for creating, a plurality of network events on the basis of a content of each packet.

At step 604, the processor 201 may be configured for identifying, a pattern of the plurality of network events in the network data flow based on the knowledge based finite state machine defined between each pair of computers connected in the network.

At step 605, the processor 201 may be configured for feeding, identified pattern of the plurality of network events into an Incremental Probability Action Modelling (IPAM) engine in order to predict a next state in the identified pattern based on a probability of network events.

At step 606, the IPAM engine module 207 may be configured for preparing, a probability grid with the probability of the next state as a warning state. In one embodiment, the probability grid may be used in order to predict a network status of each state.

At step 607, the alert coordination and display module 208, may be configured for generating, one or more alerts of the intrusion detection on the basis of prediction of the warning state. In one embodiment, the alert coordination and display module 209 may be configured to detect intrusion at three different stages of intrusion by generating alert at the Connection FSA, IPAM engine probability alert and the Network FSA alert. In one embodiment, the alert coordination and display module 209 may be configured to coordinate three alerts of three different stages using the decision tree. In one embodiment, the decision tree may provide a network safety ranking from 0 to 7, wherein 7 is highly danger state and 0 is the safe state.

Exemplary embodiments discussed above may provide certain advantages. Some embodiments of the present disclosure may help to detect and predict any anomalies between the pair of IPs irrespective of communication protocol, which in turn provides comprehensive view of the network as the system.

Some embodiments of present disclosure may provide the probability assessment component associated with the finite state machine in order to deliver the probability of the current abnormality to be an attack which reduces the false negatives which is the inherent limitation of all knowledge-based models known in the prior art.

Some embodiments of the present disclosure may incorporate the advantage of anomaly-based intrusion detection and knowledge-based intrusion detection by effectively combining two methods.

Some embodiments of the present disclosure may generate the sequence of network events by using the knowledge based Finite State Machines effectively. The knowledge based Finite state machine may complement the predictive model defined by IPAM which predicts the future actions based on the past actions. This prediction may be different from the normal sequence matching algorithm or Markov chain, wherein the next prediction is based on the most recent action and it implements an incremental approach, wherein a probability table is updated as recent commands with highly weighed probabilities and older events with diminishing probabilities.

We claim:

1. A system for detecting an intrusion on a network, the system comprising:
a processor; and
a memory coupled to the processor, wherein the processor is configured to execute instructions stored in the memory for
sniffing, each packet of a plurality of packets, wherein the plurality of packets is captured across a network data flow;
analysing, a header data of each packet of the plurality of packets;
creating, a plurality of network events on the basis of a content of each packet;
identifying, a pattern of the plurality of network events in the network data flow based on a knowledge based finite state machine defined between each pair of computers connected in the network;
feeding, identified pattern of the plurality of network events into an Incremental Probability Action Modelling (IPAM) engine in order to predict a next state in the identified pattern based on a probability of network events;
preparing, a probability grid with the probability of the next state as a warning state, wherein the probability grid is used in order to predict a network status of each state; and
generating, one or more alerts of the intrusion detection on the basis of prediction of the warning state.

2. The system of claim 1, wherein a packet sniffing module is configured for sniffing the plurality of packets.

3. The system of claim 1, wherein a network event generator is configured to analyse the header data of each packet of the plurality of packets.

4. The system of claim 1, wherein the one or more alerts are generated at a connection Finite state automata (FSA), the IPAM engine and a network Finite state automata (FSA).

5. The system of claim 4, wherein the connection Finite state automata (FSA) embraces all possible states using finite state machine defined between each pair of computers connected in the network.

6. The system of claim 4, wherein the network Finite state automata (FSA) defines the status of the network on the basis of the states of each Connection FSA is at a given time, wherein a statistical data of the states provides the condition for the state change in Network FSA.

7. A method for detecting an intrusion on a network, comprising:
sniffing, via a processor, each packet of a plurality of packets, wherein the plurality of packets is captured across a network data flow;
analysing, via the processor, a header data of each packet of the plurality of packets;
creating, via the processor, a plurality of network events on the basis of a content of each packet;
identifying, via the processor, a pattern of the plurality of network events in the network data flow based on a knowledge based finite state machine defined between each pair of computers connected in the network;
feeding, via the processor, identified pattern of the plurality of network events into an Incremental Probability Action Modelling (IPAM) engine in order to predict a next state in the identified pattern based on a probability of network events;
preparing, via the processor, a probability grid with the probability of the next state as a warning state, wherein the probability grid is used in order to predict a network status of each state; and
generating, via the processor, one or more alerts of the intrusion detection on the basis of prediction of the warning state.

8. The method of claim 7, wherein the one or more alerts are generated at a connection Finite state automata (FSA), the IPAM engine and a network Finite state automata (FSA).

9. The method of claim 8, wherein the connection Finite state automata (FSA) embraces all possible states using finite state machine defined between each pair of computers connected in the network.

10. The method of claim 8, wherein the network Finite state automata (FSA) defines the status of the network on the basis of the states of each Connection FSA is at a given time, wherein a statistical data of the states provides the condition for the state change in Network FSA.
